(19) United States
(12) Patent Application Publication
(10) Pub. No.: US 2015/0212538 A1
(43) Pub. Date: Jul. 30, 2015

(54) TOUCH PANEL AND TOUCH SENSING DEVICE

(71) Applicant: SAMSUNG ELECTRO-MECHANICS CO., LTD., Suwon (KR)

(72) Inventors: Hyun Dong LEE, Suwon (KR); Youn Soo Kim, Suwon (KR); Sung Han, Suwon (KR); Seung Min Lee, Suwon (KR); Jae Ho Shin, Suwon (KR)

(73) Assignee: SAMSUNG ELECTRO-MECHANICS CO., LTD., Suwon (KR)

(21) Appl. No.: 14/249,719

(22) Filed: Apr. 10, 2014

(30) Foreign Application Priority Data
Jan. 24, 2014 (KR) 10-2014-0008848

(51) Int. Cl. G06F 1/16; G06F 3/041

(52) U.S. Cl. CPC G06F 1/16; G06F 3/041; G06F 3/0416

(57) ABSTRACT

A touch panel may include: at least one substrate; a sensor part formed on a mounting region of the at least one substrate so as to sense a user's touch; a wiring unit delivering a detection signal from each sensor node in the sensor part; and a connection part including a plurality of pads to receive detection signals from the wiring unit. The plurality of pads are arranged in at least two rows, with at least two pads in each row.

### CROSS-REFERENCE TO RELATED APPLICATION

This application claims the benefit of Korean Patent Application No. 10-2014-0008848 filed on Jan. 24, 2014, with the Korean Intellectual Property Office, the disclosure of which is incorporated herein by reference.

### BACKGROUND

The present disclosure relates to a touch panel and a touch sensing device having enhanced adhesive properties.

As computer technology has advanced, computer peripheral devices have also been developed. Personal computers, portable transmitters and other personal information processors execute processing of text and graphics using a variety of data input devices such as keyboards and computer mice.

The use of computers is ever-increasing due to the rapid transition to information-oriented societies in many regions. However, existing keyboards and mice currently serving as data input devices have limits in allowing for the efficient operation of electronic devices. Therefore, required is a device that is simple, unlikely to be miss-operated, and easy for all users to input data thereto.

In addition, techniques for input devices have progressed toward techniques related to high degrees of reliability, durability, innovation, advanced design and processing, beyond a level satisfying general functions. To this end, touch panels have been developed for use as data input devices allowing users to input information such as text, graphics, or the like. In addition, techniques for input devices are evolving not just to realize general functions but to achieve high degrees of reliability, durability, innovation, advanced design and processing. To this end, a touch panel (touchscreen) has been developed as an data input device capable of allowing a user to input information such as text information, graphic information or the like.

Such a touch panel is mounted on a display screen of a display such as an electronic organizer, a flat panel display device including a liquid crystal display (LCD) device, a plasma display panel (PDP), an electroluminescence (El) element or the like, or a cathode ray tube (CRT), so that a user can select desired information while viewing the display.

Touch panels are is classified as resistive type touch panels, capacitive type touch panels, electromagnetic type touch panels, surface acoustic wave (SAW) type touch panels, and infrared type touch panels.

These various types of touch panel are selectively employed in electronic devices, depending on factors such as signal amplification, differences in resolution, difficulty in design and manufacturing processes, optical properties, electrical properties, mechanical properties, resistance to external environments, input characteristics, durability, and economic efficiency. Currently, resistive type touch panels and capacitive type touch panels are most commonly used.

An example of such a touch panel may include a substrate, electrodes formed on the substrate, electrode wirings extended from the electrodes and gathered at one end of the substrate, and a controller connected to the electrode wirings through a flexible printed circuit board (hereinafter, referred to as a ‘FPCB’).

Here, the FPCB serves to transfer signals generated in the electrodes to the controller through the electrode wirings. The connection between the FPCB and the electrode wirings should be secured in order to obtain reliability of the signal transfer by the FPCB.

However, such previously used connection structures have, on occasion, failed to provide sufficient amounts of adhesion, as touch panels become larger and the number of channels is accordingly increased.

### SUMMARY

An aspect of the present disclosure may provide a touch panel and a touch sensing device having enhanced adhesive properties with improved pad structure in a touch panel.

According to an aspect of the present disclosure, a touch panel may include: at least one substrate; a sensor part formed on a mounting region of the at least one substrate so as to sense a user's touch; a wiring unit delivering a detection signal from each sensor node in the sensor part; and a connection part including a plurality of pads to receive detection signals from the wiring unit, the plurality of pads being arranged in at least two rows, with at least two pads in each of the rows.

The connection part may be extended from the at least one substrate.

The at least one substrate may include a plurality of substrates, wherein each of the plurality of substrates has a sensor part and a wiring unit formed thereon, and a connection part extended therefrom, the connection part includes a plurality of pads to receive detection signals from the wiring unit, the plurality of pads is arranged in at least one row, with least two pads in the row, on the respective connection part.

A lamination layer may be formed between every two substrates.

The wiring unit may be formed between the at least two pads on the connection part so as to be connected to a corresponding pad.

According to another aspect of the present disclosure, a touch sensing device may include: a touch panel including a first substrate unit having at least one substrate, a sensor part formed on a mounting region of the at least one substrate of the first substrate unit so as to sense a user's touch, a wiring unit delivering a detection signal from each sensor node in the sensor part, and a first connection part including a plurality of pads, each of the pads receiving the detection signal from the wiring unit, the plurality of pads being arranged in at least two rows, with at least two pads in each of the rows; and a control part electrically connected to the first connection unit so as to process the detection signal.

The control part may include: a second substrate unit having at least one substrate; a second connection part extended from the at least one substrate of the second substrate unit and having a plurality of pads to be electrically connected to the first connection part; and a signal processing part mounted on the at least one substrate of the second substrate unit and processing a detection signal transmitted from the second connection part so as to detect a user's touch.

The control part may include: a second substrate unit having a plurality of substrates; a second connection part extended from a corresponding one of the plurality of substrates of the second substrate unit and having a plurality of pads to be electrically connected to a corresponding first connection part; and a signal processing part mounted on the at least one of the substrates of the second substrate unit and processing a detection signal transmitted from each of the pads on the second connection part so as to detect a user's touch.

The pads on the first connection part and the pads on the second connection part may have connection members therebetween.

The connection members may be anisotropic conductive films (ACFs) formed of solder balls and resins.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a touch panel according to an exemplary embodiment of the present disclosure;

FIGS. 2A and 2B are a front view and a side view of the connection part formed in the touch panel according to the exemplary embodiment, respectively;

FIG. 3 is a perspective view of a touch sensing device according to an exemplary embodiment of the present disclosure;

FIGS. 4A and 4B are diagrams in which the connection part in the touch panel and the connection part of the control part according to the exemplary embodiment are coupled with each other;

FIG. 5 is an exploded perspective view of a touch panel according to another exemplary embodiment of the present disclosure;

FIGS. 6A and 6B are a front view and a side view of the connection part employed in the touch panel shown in FIG. 5, respectively; and

FIGS. 7A and 7B are diagrams in which the connection part in the touch panel and the connection part of the control part shown in FIG. 5 are coupled with each other.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

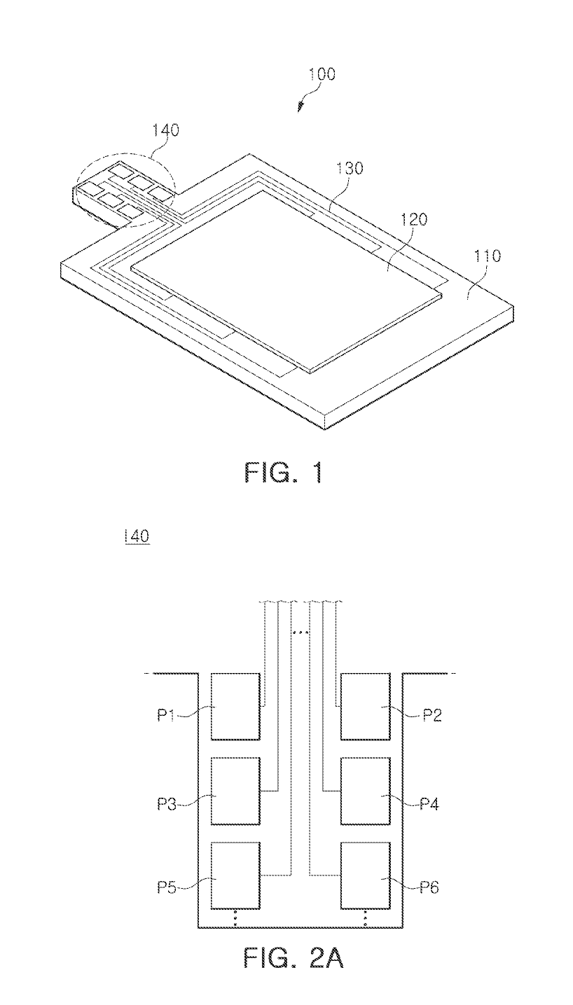

FIG. 1 is a perspective view of a touch panel according to an exemplary embodiment of the present disclosure.

Referring to FIG. 1, the touch panel 100 according to the exemplary embodiment may include a substrate 110, a sensor part 120, a wiring unit 130, and a connection part 140.

The substrate 110 may have a mounting region having a predetermined area on which the sensor part 120 and the wiring unit 130 may be formed.

The sensor part 120 may include a plurality of sensor nodes. The plurality of sensor nodes may receive a user's touch to provide a detection signal. The sensor unit 120 may receive a user's touch in a capacitive manner or in a pressure-sensitive manner.

The wiring unit 130 may be connected to the plurality of sensor nodes in the sensor part 120 to deliver a detection signal detected by each of the sensor nodes to the outside.

The connection part 140 may be formed in a portion extended from one side of the substrate 110 and may include a plurality of pads P1 to P6, each of which is electrically connected to the respective wirings in the wiring unit 120.

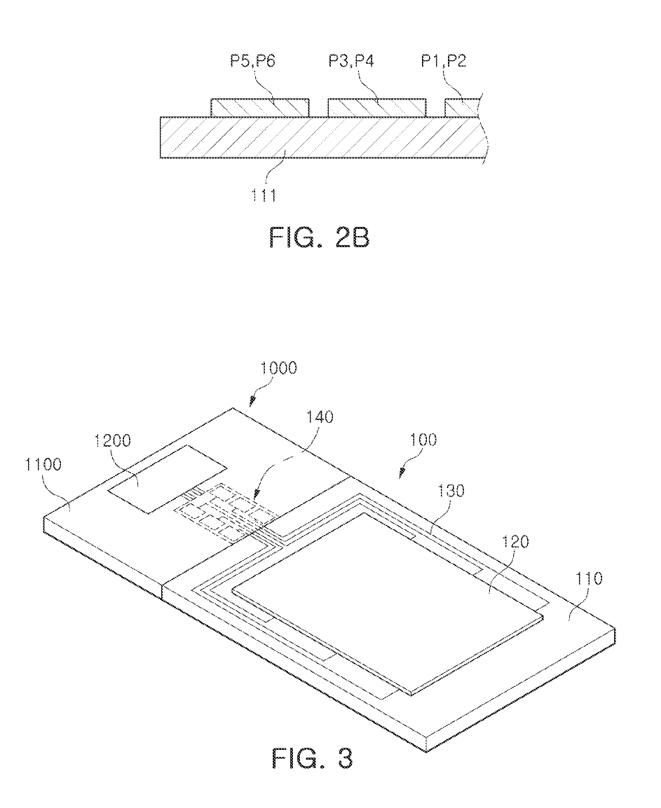

FIGS. 2A and 2B are a front view and a side view of the connection part formed in the touch panel according to the exemplary embodiment, respectively.

Referring to FIG. 2A, the plurality of pads P1 to P6 may be arranged in at least two rows, each of which includes at least two pads P1 and P2, P3 and P4, and P5 and P6, respectively. When there are six pads as shown in the example, the six pads are arranged in three rows, each of which includes two pads. However, the arrangement of the plurality of pads P1 to P6 is not limited thereto but may be variable. Although not shown, three or four pads may be arranged in two rows, or four or more pads may be arranged in two or more rows.

As can be seen from FIG. 2B, the plurality of pads P1 to P6 may be arranged in the extended portion 111 extended from the substrate 110.

As described above, on the connection part 140 employed in the touch panel according to the exemplary embodiment, a plurality of pads P1 to P6 are arranged in at least two rows, so that the extended portion 111 is enlarged due to the arrangement of two or more rows and the plurality of pads P1 to P6 arranged on the extended portion 111 are also enlarged, thereby enhancing adhesion.

FIG. 3 is a perspective view of a touch sensing device according to an exemplary embodiment of the present disclosure.

Referring to FIG. 3, touch sensing device according to the exemplary embodiment may include a touch panel 100 and a control part 1000.

The touch panel 100 is identical to that described with respect to FIGS. 1, 2A and 2B and, therefore, redundant description will not be made.

The control part 1000 may include a second connection part connected to the first connection part 140 of the touch panel 100, and a signal processing part 1200 processing a detection signal transmitted from the second connection part so as to recognize a user's touch.

The second connection part may be formed on a second substrate 1100 which is different from the first substrate 110 of the touch panel 100, and the signal processing part 1200 may be formed on a mounting region in the second substrate 1100.

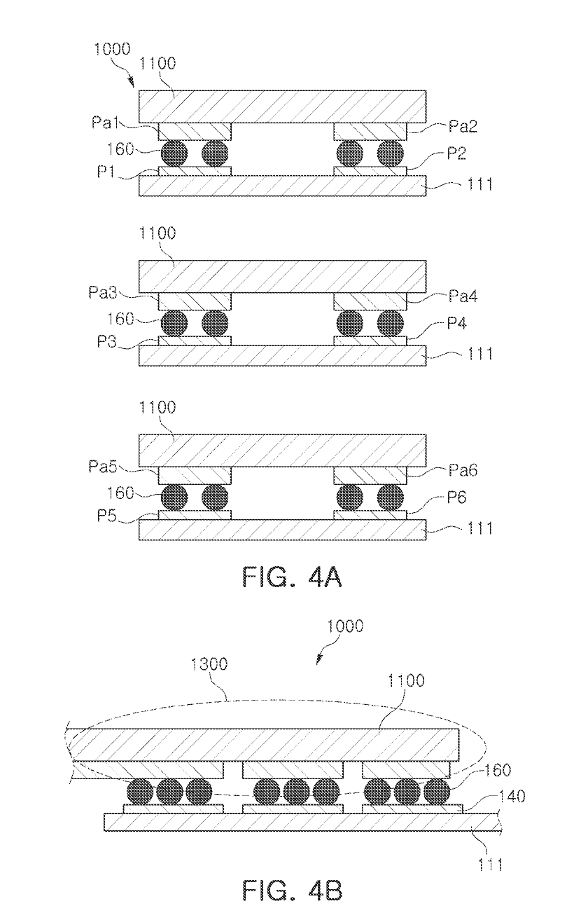

FIGS. 4A and 4B are diagrams in which the connection part of the touch panel and the connection part of the control part according to the exemplary embodiment are coupled with each other.

Referring to FIGS. 4A and 4B, the first connection part 140 of the touch panel may be electrically connected to the second connection part 1300 of the control part 1000. The pads P1 to P6 on the first connection part 140 and pads Pa1 to Pa6 on the second connection unit 1300 may have connection members 160 therebetween. The connection members 160 may be anisotropic conductive films (ACFs). The ACF may include a thermosetting resin and a conductive ball.

Each of the pads P1 to P6 on the first connection part 140 may be connected to a corresponding one of the pads Pa1 to Pa6 on the second connection part 1300 via respective connection members 160.

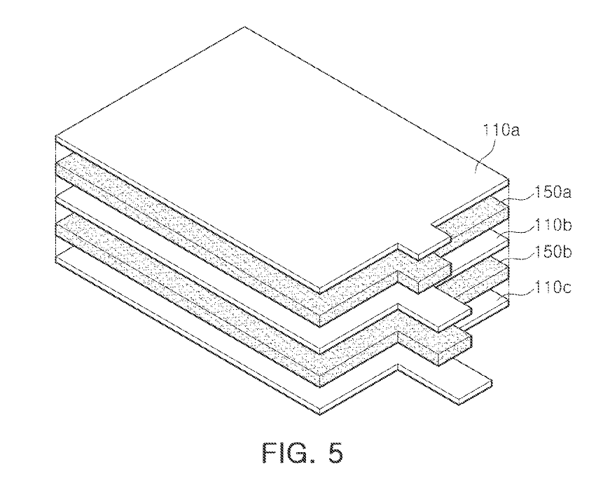

FIG. 5 is an exploded perspective view of a touch panel according to another exemplary embodiment of the present disclosure.

Referring to FIG. 5, a substrate unit of the touch panel according to this exemplary embodiment may include a plurality of substrates 110a, 110b and 110c. Although the substrate unit includes first to third substrates 110a, 110b and 110c in FIG. 5, the number of substrates are not limited thereto. For example, there may be at least two substrates.

Between the first and second substrate 110a and 110b, and between the second and third substrates 110b and 110c, lamination layers 150a and 150b may be formed, respectively. The first lamination layer 150a may be formed between the first and second substrates 110a and 110b and may have the same area and shape with the first substrate 110a. The second lamination layer may be formed between the second and third substrates 110b and 110c and may have the same area and shape with the second substrate 110b.

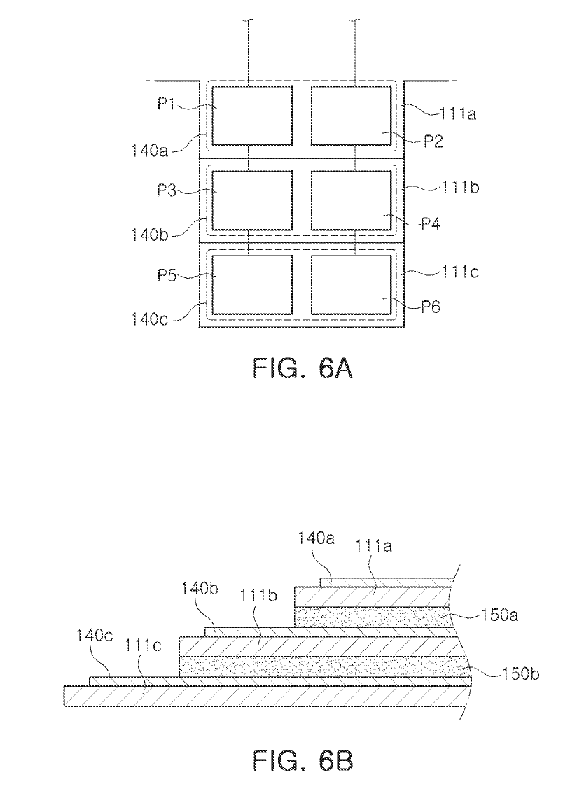

FIGS. 6A and 6B are a front view and a side view of the connection part employed in the touch panel shown in FIG. 5, respectively.

Referring to FIGS. 6A and 6B, the connection part 140 may include first to third connection units 140a, 140b and 140c in the first to third extended portions 111a, 111b, and 111c, respectively, each of which is extended from one side of the first to the third substrates 110a, 110b, and 110c, respectively. On each of the connection units, at least two pads P1 and P2, P3 and P4, and P5 and P6, respectively, are arranged in at least one row. Although two pads P1 and P2, P3 and P4, and P5 and P6, respectively, are arranged in one row in the shown example, the numbers of pads and rows are not limited thereto. For example, one row may include two or more pads, or each of plural rows may include a plurality of pads.

The first to third extended portions 111a, 111b and 111c may be stacked on one another so that they have a stepped shape when seen from the side thereof.

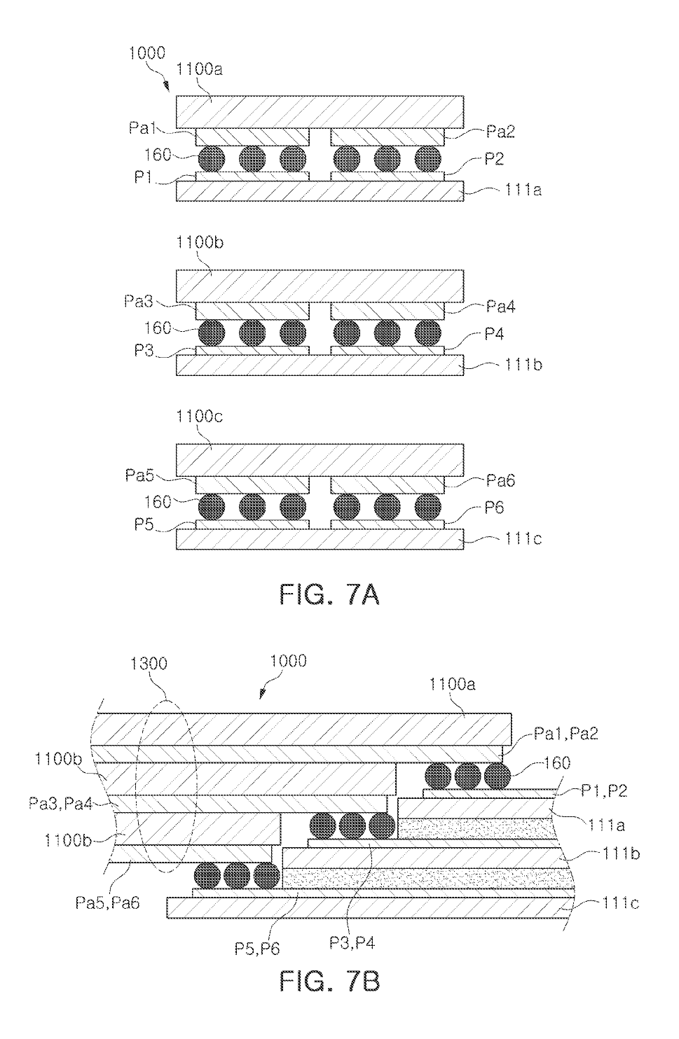

FIGS. 7A and 7B are diagrams in which the connection part of the touch panel and the connection part of the control part of the touch panel shown in FIG. 5 are coupled with each other.

Referring to FIGS. 7A and 7B, the first connection part 140 of the touch panel may be electrically connected to the second connection part 1300 of the control part 1000. The pads P1 and P2, P3 and P4, and P5 and P6 in the first to third connection units 140a, 140b, and 140c of the first connection unit 140, respectively, and pads Pa1 and Pa2, Pa3 and Pa4, and Pa5 and Pa6 in the first to third connection units 1300a, 1300b, and 1300c of the second connection part 1300 may have connection members 160 therebetween. The connection members 160 may be anisotropic conductive films (ACFs).

The pads P1 and P2, P3 and P4, and P5 and P6 on the first to third connection units 140a, 140b and 140c of the first connection part 140, respectively, may be connected to a corresponding one of the pads Pa1 and Pa2, Pa3 and Pa4, and Pa5 and Pa6 on the first to third connection units 1300a, 1300b and 1300c of the second connection part 1300, respectively, via respective connection members 160.

Since the first to third connection units 140a, 140b and 140c of the first connection part 140 have a stepped shape, the first to third connection units 1300a, 1300b and 1300c of the second connection part 1300 may be stacked so that they have a stepped shape as seen from the side thereof as well. For being coupled with the stepped shape of the first to third connection units of the first connection part 140, the first to third connection units 1300a, 1300b and 1300c of the second connection part 1300 may have the inverted stepped shape.

As described above, according to exemplary embodiments of the present disclosure, pads may be formed in plural layers or plural rows to thereby enlarge the area in which ACFs are attached, so that adhesion and durability may be enhanced.

As set forth above, according to exemplary embodiments of the present disclosure, pads are formed in plural layers or plural rows to thereby enlarge the area in which anisotropic conductive films (ACFs) are attached, so that adhesion and durability may be enhanced.

While exemplary embodiments have been shown and described above, it will be apparent to those skilled in the art that modifications and variations could be made without departing from the spirit and scope of the present disclosure as defined by the appended claims.

What is claimed is:

1. A touch panel, comprising:
at least one substrate;
a sensor part disposed on amounting region of the at least one substrate so as to sense a user's touch;
a wiring unit delivering a detection signal from each sensor node in the sensor part; and
a connection part including a plurality of pads to receive detection signals from the wiring unit, the plurality of pads being arranged in at least two rows, with at least two pads in each row.

2. The touch panel of claim 1, wherein the connection part is extended from the at least one substrate.

3. The touch panel of claim 1, wherein the at least one substrate includes a plurality of substrates, wherein each of the plurality of substrates has a sensor part and a wiring unit formed thereon, and a connection part extended therefrom, wherein the connection part includes a plurality of pads to receive detection signals from the wiring unit, and the plurality of pads is arranged in at least one row, with at least two pads in the row, on the connection part.

4. The touch panel of claim 3, wherein a lamination layer is formed between every two substrates.

5. The touch panel of claim 1, wherein the wiring unit is formed between the at least two pads on the connection part so as to be connected to a corresponding pad.

6. A touch sensing device, comprising:
a touch panel, including
a first substrate unit having at least one substrate,
a sensor part disposed on a mounting region of the at least one substrate of the first substrate unit so as to sense a user's touch,
a wiring unit delivering a detection signal from each sensor node in the sensor part, and
a first connection part including a plurality of pads to receive detection signals from the wiring unit, the plurality of pads being arranged in at least two rows, with at least two pads in each of the rows; and
a control part electrically connected to the first connection unit so as to process the detection signal.

7. The touch sensing device of claim 6, wherein the first connection part is extended from the at least one substrate.

8. The touch sensing device of claim 6, wherein the first substrate unit includes a plurality of substrates, wherein each of the plurality of substrates has a sensor part and a wiring unit formed thereon, and a first connection part extended therefrom, wherein the first connection part includes a plurality of pads to receive detection signals from the wiring unit, and the plurality of pads is arranged in at least one row, with least two pads in the row, on the connection part.

9. The touch sensing device of claim 8, wherein a lamination layer is formed between every two substrates.

10. The touch sensing device of claim 6, wherein the wiring unit is formed between at least two pads on the first connection part so as to be connected to a corresponding pad.

11. The touch sensing device of claim 6, wherein the control part includes:
a second substrate unit having at least one substrate;
a second connection part extended from the at least one substrate of the second substrate unit and having a plurality of pads to be electrically connected to the first connection part; and
a signal processing part mounted on the at least one substrate of the second substrate unit and processing a detection signal transmitted from the second connection part so as to detect a user's touch.

12. The touch sensing device of claim 8, wherein the control part includes:
a second substrate unit having a plurality of substrates;
a second connection part extended from a corresponding one of the plurality of substrates of the second substrate unit and having a plurality of pads to be electrically connected to a corresponding first connection part; and
a signal processing part mounted on the at least one of the substrates of the second substrate unit and processing a detection signal transmitted from each of the pads on the second connection part so as to detect a user's touch.

13. The touch sensing device of claim 11, wherein the pads on the first connection part and the pads on the second connection part have connection members therebetween.

14. The touch sensing device of claim 13, wherein the connection members are anisotropic conductive films (ACFs) formed of solder balls and resins.

15. The touch sensing device of claim 12, wherein the pads on the first connection part and the pads on the second connection part have connection members therebetween.
